(19) United States
(12) Patent Application Publication
(10) Pub. No.: US 2026/0171305 A1
(43) Pub. Date: Jun. 18, 2026

(54) MULTIPHASE OR HIGH-LEVEL COUPLED INDUCTOR

(71) Applicant: TAI-TECH ADVANCED ELECTRONICS CO., LTD., Taoyuan City (TW)

(72) Inventors: Chang-Han YU, Taoyuan City (TW); Ming-Yen HSIEH, Taoyuan City (TW); Kuan-Yi LU, Taoyuan City (TW)

(21) Appl. No.: 18/984,943

(22) Filed: Dec. 17, 2024

(51) Int. Cl. H01F 37/00; H01F 1/147; H01F 27/24; H01F 27/32

(52) U.S. Cl. CPC H01F 37/00; H01F 1/14791; H01F 27/24; H01F 27/323

(57) ABSTRACT

A multiphase or high-level coupled inductor includes an iron core, which includes first and second side surfaces opposite to each other and a third side surface between the first and second side surfaces, the iron core including receiving portions spaced from each other; and coil windings each including first and second windings and respectively arranged on the receiving portions. The first winding is formed with a hollowed portion having a first length and a first width. The first winding includes first and second bend portions, which are bent in different directions. The first bend portion is exposed on the second side surface of the iron core. The second winding is arranged in the hollowed portion of the first winding and has a second length and a second width. The first length is greater than the second length, and the first width is greater than the second width.

### BACKGROUND OF THE INVENTION

### (a) Technical Field of the Invention

The present invention relates to an inductor, and more particularly to a multiphase or high-level coupled inductor.

### (b) Description of the Prior Art

A coupled inductor is composed of two or more coil windings, which fulfills transmission of energy and signal through sharing of magnetic field and mutual inductance. Compared with ordinary inductors, the coupled inductors have a stronger electromagnetic coupling effect. Generally speaking, as being affected by space and size, the two coils of a coupled inductor are often arranged in an overlapping manner, and the coupling effect is better with the coils being closer to each other, but not in contact with each other, otherwise shoring may result. The operation principle of coupled inductors is based on electromagnetic induction and mutual inductance. When a current passes through one coil, a magnetic field is generated around the coil. If another coil is close and shares a magnetic field with it, a voltage will be generated in the second coil.

Referring to FIG. 7, a prior art coupled inductor comprises a prior art iron core 10 and a prior art coil winding 20. The prior art coil winding 20 comprises a prior art first winding 210 and a prior art second winding 220. The prior art first winding 210 and the prior art second winding 220 are arranged on the prior art iron core 10, and a gap is formed between the prior art first winding 210 and the prior art second winding 220.

Test data of the prior art coupled inductor is listed in the following Table 4:

TABLE 4

| | prior art first | prior art second |
|---|---|---|
| | winding (nH) | winding (nH) |
| Inductance (nH) | 87.6 | 87.4 |

| | |
|---|---|
| Coupling Coefficient K | 0.5028 |

| | | |
|---|---|---|
| DC Resistance (mΩ) | <0.14 | <0.58 |

However, the prior art comprises just one coil winding 20, and the coupling coefficient K is 0.5028, and thus has a problem of the coupling coefficient being low.

### SUMMARY OF THE INVENTION

To achieve the above purposes, the present invention provides a multiphase or high-level coupled inductor, which comprises: an iron core, wherein the iron core has a first side surface and a second side surface that are opposite to each other, and a third side surface located between the first side surface and the second side surface, and the iron core is provided with a plurality of receiving portions that are spaced from each other; and a plurality of coil windings, wherein the plurality of coil windings each at least comprise a first winding and a second winding, and the plurality of coil windings are respectively disposed on the plurality of receiving portions of the iron core, the first winding being formed with a hollowed portion, the hollowed portion having a first length and a first width, the first winding comprising a first bend portion and a second bend portion, the first bend portion and the second bend portion being bent in different directions, the first bend portion being exposed on the second side surface of the iron core, the second winding being arranged in the hollowed portion of the first winding, the second winding having a second length and a second width, the first length being greater than the second length, the first width being greater than the second width.

In the above, two adjacent ones of the coil windings are arranged in opposite directions.

In the above, a gap is formed between the first winding and the second winding.

In the above, at least an isolation layer is arranged between the first winding and the second winding.

In the above, the iron core comprises ferrosilicon (FeSi) or iron silicon aluminum (FeSiAl).

As such, the plurality of coil windings help increases the coupling coefficient K, in order to improve the overall performance of the coupled inductor.

### BRIEF DESCRIPTION OF THE DRAWINGS

FIG. 1 is a schematic view showing a multiphase or high-level coupled inductor according to the present invention.

FIG. 2 is a schematic view showing a portion of the multiphase or high-level coupled inductor according to the present invention.

FIG. 3 is a schematic view showing an iron core according to the present invention including three coil windings.

FIG. 4 is a schematic view showing a first embodiment of the present invention.

FIG. 5 is a schematic view showing a second embodiment of the present invention.

FIG. 6 is a schematic view showing a third embodiment of the present invention.

FIG. 7 is a schematic view showing a prior art coupled inductor.

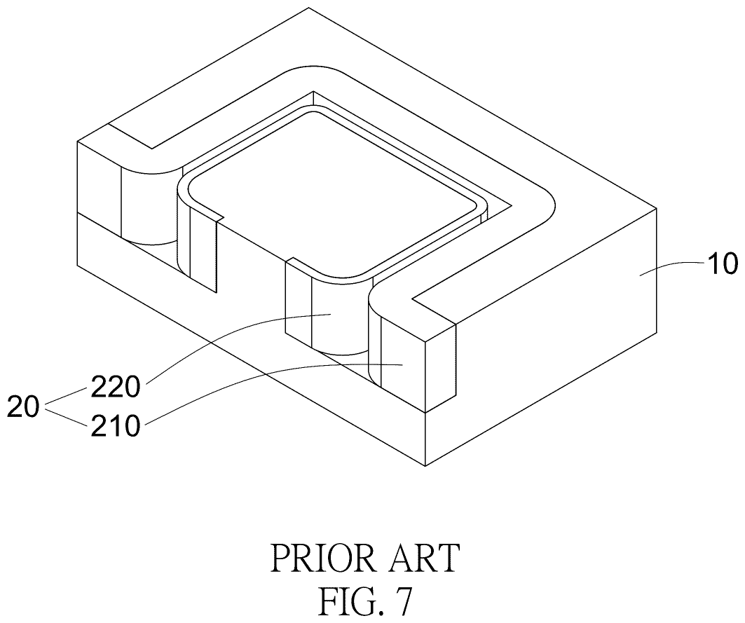

### DETAILED DESCRIPTION OF THE PREFERRED EMBODIMENTS

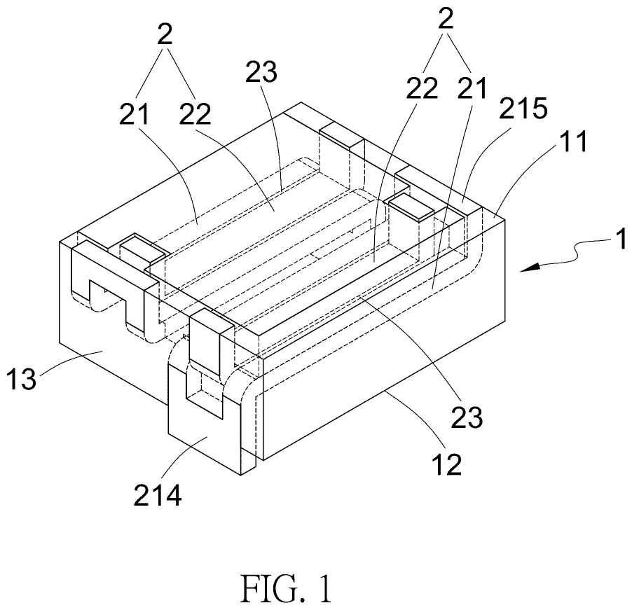

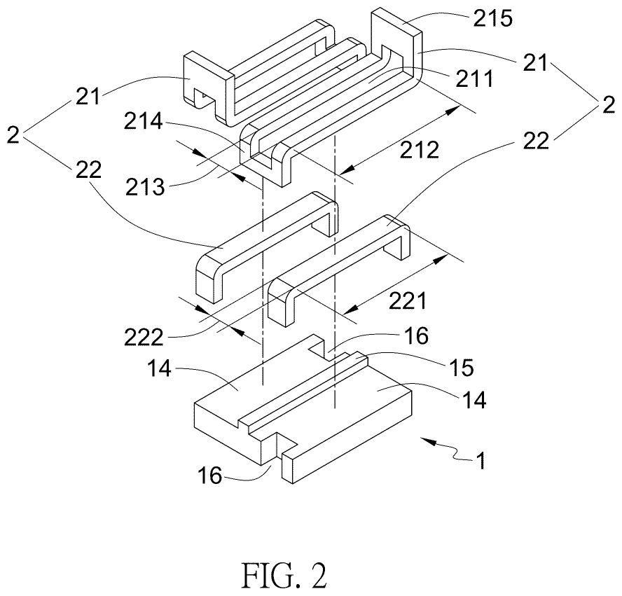

Referring to FIGS. 1 and 2, the present invention provides a multiphase or high-level coupled inductor, which comprises:
an iron core 1, wherein the iron core 1 includes a first side surface 11 and a second side surface 12 that are opposite to each other, and a third side surface 13 that is between the first side surface 11 and the second side surface 12, and the iron core 1 is provided with a plurality of receiving portions 14 that are spaced from each other; two adjacent ones of the receiving portions 14 are provided with a separation portion 15 arranged therebetween, and the separation portion 15 divides the iron core 1 into the plurality of receiving portions 14; and the iron core 1 may comprise ferrosilicon (FeSi) or iron silicon aluminum (FeSiAl); and
a plurality of coil windings 2, wherein the plurality of coil windings 2 each at least comprise a first winding 21 and a second winding 22, and the plurality of coil windings 2 are respectively disposed on the plurality of receiving portions 14 of the iron core 1, the first winding 21 being formed with a hollowed portion 211, the hollowed portion 211 having a first length 212 and a first width 213, the first winding 21 including a first bend portion 214 and a second bend portion 215, the first bend portion 214 and the second bend portion 215 being bent in different directions, the first bend portion 214 being exposed on the second side surface 12 of the iron core 1, the second winding 22 being arranged in the hollowed portion 211 of the first winding 21, the second winding 22 having a second length 221 and a second width 222, the first length 212 being greater than the second length 221, the first width 213 being greater than the second width 222.

Two adjacent ones of the coil windings 2 are arranged in opposite directions. A gap 23 or at least one isolation layer is arranged between the first winding 21 and the second winding 22 to prevent shorting. The isolation layer may comprise a non-conductive body. Or alternatively, the second winding 22 may comprise an enameled wire or an outer layer of the second winding 22 is provided with a coating for isolation. Further, the iron core 1 is formed with a plurality of engagement and retention portions 16 to respectively engage and retain the plurality of second windings 22 in position. The engagement and retention portion 16 can be a notch.

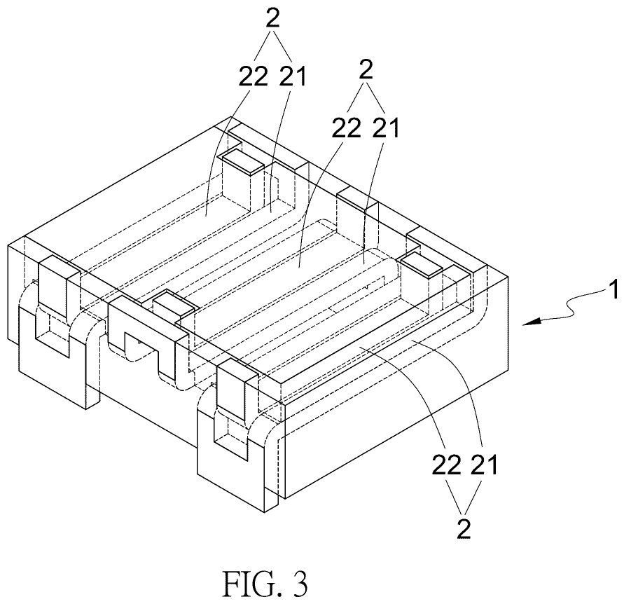

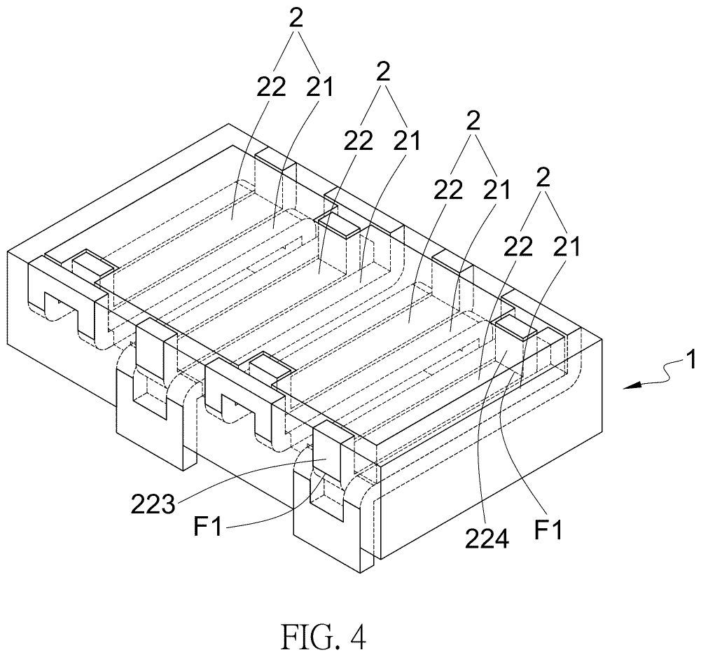

Referring to FIGS. 1, 3, and 4, in FIG. 1, the iron core 1 is provided with two coil windings 2. In FIG. 3, the iron core 1 is provided with three coil windings 2. In FIG. 4, the iron core 1 is provided with four coil windings 2.

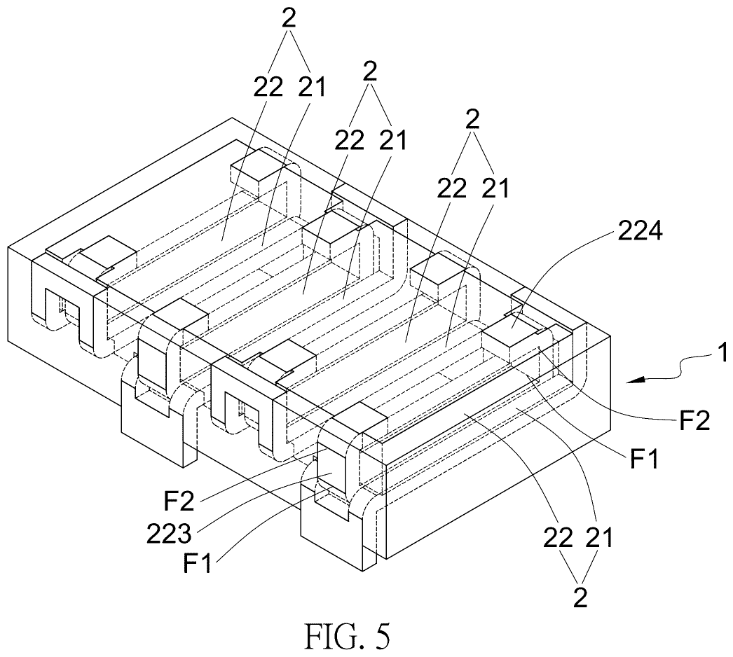

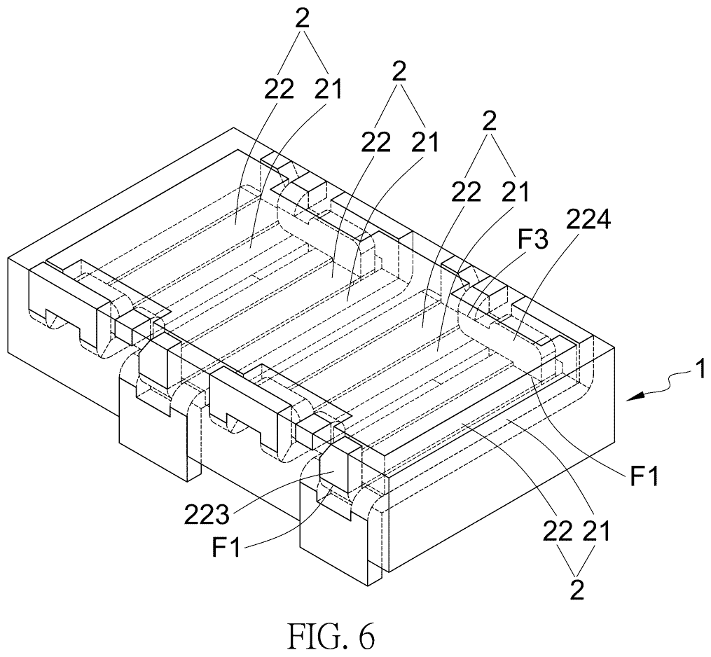

Referring to FIGS. 4, 5, and 6, the second winding 22 includes a third bend portion 223 and a fourth bend portion 224, and the number and direction of bending that makes the third bend portion 223 and the fourth bend portion 224 may be set according to practical needs. Three illustrative embodiments are provided for illustrating the second winding 22, wherein the first embodiment is shown in FIG. 4; the second embodiment is shown in FIG. 5; and the third embodiment is shown in FIG. 6. In FIG. 4, the third bend portion 223 is bent one time along a bending line F1, and the fourth bend portion 224 is also bent one time along the bending line F1, and the bending directions are the same. In FIG. 5, the third bend portion 223 is bent two times respectively along a bending line F1 and a bending line F2, and the fourth bend portion 224 is also bent two times along the bending line F1 and the bending line F2. In FIG. 6, the third bend portion 223 is bent one time along a bending line F1, and the fourth bend portion 224 is bent one time along each of a bending line F1 and a bending line F3, and bending directions are different.

Test data of the first embodiment are listed in the following Table 1:

TABLE 1

| Type I | first winding (nH) | second winding (nH) |
|---|---|---|
| Inductance (nH) | 55.056 | 68.373 |
| Coupling Coefficient K | 0.696 | |
| DC Resistance (mΩ) | <0.35 | <0.8 |

Test data of the second embodiment are listed in the following Table 2:

TABLE 2

| Type II | first winding (nH) | second winding (nH) |
|---|---|---|
| Inductance (nH) | 58.443 | 80.974 |
| Coupling Coefficient K | 0.7019 | |
| DC Resistance (mΩ) | <0.3 | <0.8 |

Test data of the third embodiment are listed in the following Table 3:

TABLE 3

| Type III | first winding (nH) | second winding (nH) |
|---|---|---|
| Inductance (nH) | 54.357 | 87.832 |
| Coupling Coefficient K | 0.7199 | |
| DC Resistance (mΩ) | <0.3 | <0.8 |

The present invention includes provides the following advantages:
(1) High level of coupling: the coupling coefficient K is high, and as shown in Tables 1, 2, and 3, the coupling coefficient K is 0.696, 0.7019, and 0.7199 respectively, while the coupling coefficient K of the prior art coupled inductor is 0.5028.
(2) Alloy powder molding: alloy powder is used to mold and make the iron core 1, and the iron core 1 may comprise ferrosilicon (FeSi) or iron silicon aluminum (FeSiAl).
(3) Each coil winding 2 at least including two windings, which are respectively the first winding 21 and the second winding 22.
(4) The first winding 21 including a hollowed portion 211 for receiving the second winding 22 to dispose therein, the first winding 21 and the second winding 22 overlapping each other to make the size of the entire structure thinned.
(5) A gap 23 or at least one isolation layer (non-conductive body) being formed between the first winding 21 and the second winding 22 to prevent shorting.
(6) The second winding 22 including enameled wire, or alternatively, an outer layer of the second winding 22 being provided with a coating for insulation.
(7) Two adjacent ones of the coil windings 2 being arranged in opposite directions.

As such, the plurality of coil windings 2 help increase the coupling coefficient K in order to improve the overall performance of the coupled inductor.

I claim:

1. A multiphase or high-level coupled inductor, comprising:
an iron core, wherein the iron core has a first side surface and a second side surface that are opposite, and a third side surface located between the first side surface and the second side surface, and the iron core is provided with a plurality of receiving portions spaced from each other; and
a plurality of coil windings, wherein the plurality of coil windings each at least comprise a first winding and a second winding, and the plurality of coil windings are respectively arranged on the plurality of receiving portions of the iron core, the first winding being formed with a hollowed portion, the hollowed portion having a first length and a first width, the first winding comprising a first bend portion and a second bend portion, the first bend portion and the second bend portion being bent in different directions, the first bend portion being exposed on the second side surface of the iron core, the second winding being arranged in the hollowed portion of the first winding, the second winding having a second length and a second width, the first length being greater than the second length, the first width being greater than the second width.

2. The multiphase or high-level coupled inductor according to claim 1, wherein two adjacent ones of the coil windings are arranged in opposite directions.

3. The multiphase or high-level coupled inductor according to claim 1, wherein a gap is formed between the first winding and the second winding.

4. The multiphase or high-level coupled inductor according to claim 1, wherein at least an isolation layer is arranged between the first winding and the second winding.

5. The multiphase or high-level coupled inductor according to claim 1, wherein the iron core comprises ferrosilicon (FeSi) or iron silicon aluminum (FeSiAl).
